(19) United States
(12) Patent Application Publication
(10) Pub. No.: US 2014/0313711 A1
(43) Pub. Date: Oct. 23, 2014

(54) LIGHT EMITTING DIODE (LED) LIGHT TUBE

(71) Applicant: GEM WELTRONICS TWN CORPORATION, Hsinchu County (TW)

(72) Inventors: Jon-Fwu Hwu, Hsinchu County (TW); Yung-Fu Wu, Hsinchu County (TW); Kui-Chiang Liu, Hsinchu County (TW)

(73) Assignee: GEM WELTRONICS TWN CORPORATION, Hsinchu County (TW)

(21) Appl. No.: 13/864,496

(22) Filed: Apr. 17, 2013

(51) Int. Cl. F21V 29/00

(52) U.S. Cl. CPC F21V 29/22
USPC 362/218

(57) ABSTRACT

A Light Emitting Diode (LED) light tube includes a heat dissipation base having a light emitting side formed with a recess and at least one illumination unit and a bridging unit disposed on a bottom surface of the recess. The illumination unit and the bridging unit are connected electrically relative to each other via wire-bond technique. Two circuit units are disposed on the light emitting side of the heat dissipation base respectively located at two opposite sides of the recess.

### BACKGROUND OF THE INVENTION

1. Field of the Invention

The present invention relates to a Light Emitting Diode (LED) light tube, more particularly to an LED light tube having a heat dissipation base formed with a recess, in which, an illumination unit and a bridging unit are formed integrally on a bottom surface of the recess.

2. Description of the Prior Art

Owing to high efficient, long lasting, small size, low energy consuming, swift in response, and mature advance in the modern electronics lately, a majority of traditional bulbs or tubes are gradually replaced by LED light tubes.

A prior art LED light tube generally includes a light tube, a heat dissipation plate, a printed circuit board, a plurality of LED units and two electrodes. The heat dissipation plate is mounted within the light tube while the printed circuit board is mounted on the heat dissipation plate. The LED units are connected electrically with the printed circuit board.

During the assembly, the LED units are first of all soldered on the printed circuit board, after which, the LED units and the printed circuit board are mounted on the heat dissipation plate via assembly elements. The above-mentioned elements are available in form of finished products, wherein the LED units are manufactured from wafer by high-tech companies, the dies by the medium size companies while the packing is done by small size companies. In addition, the printed circuit board is fabricated via etching, exposure process and coating process.

### SUMMARY OF THE INVENTION

A prior art LED light tube includes a plurality of LED units and a printed circuit plate which are fabricated through several processes and they are assembled together so as to form the LED light tube. The preceding several processes and assembly process and several structure of the LED units and the printed circuit plate are in fact not directly related to the LED light tube so that an overall manufacturing cost thereof cannot be reduced, thereby causing a relatively large amount of materials.

Regarding an LED unit, the high tech companies usually fabricated wafers, which are transported to medium size companies, where the wafer is fabricated into LED dies, each of which is again wire bond and is molded by small size companies via molded compound to produce as the LED unit. It is noticed that a large amount of molded compound consisting of fluorescent glue is required to conduct the molded process. The manufacturing cost is therefore high and consequently results in long manufacturing time.

The main objective of the present invention is to provide an integrally formed LED light tube, which includes a heat dissipation base having a light emitting side formed with a recess and at least one illumination unit and a bridging unit disposed on a bottom surface of the recess, the illumination unit and the bridging unit are connected electrically relative to each other via wire-bond technique.

The LED light tube of the present invention further includes an optical layer covering the illumination unit and the bridging unit, and a protection layer covering the optical layer. The illumination unit is preferably constituted by a plurality of LED dies while the bridging unit is preferably constituted by a plurality of conductive elements in such a manner that each conductive element is disposed between adjacent two of the LED dies or one of the LED dies is disposed between adjacent two of the conductive elements. The adjacent two of the conductive elements are wire bond and hence establishing electrical communication therebetween.

In the present invention, the recess is relatively narrow in width and since the optical layer and the protection layer only need to cover the relatively small width of the recess for shielding the LED dies, the cost of material expense is greatly reduced and hence shortening the manufacture time.

In the present invention, the heat dissipation base, the circuit units, the LED dies and the conductive elements do not need any other element for complementing so that a relatively large amount of material can be economized and hence simplifying the manufacturing process.

One distinct feature of the present invention resides in that once the LED dies are disposed on the bottom surface of the recess in the heat dissipation base, the optical layer and the protection layer can be sequentially disposed over the LED dies, thereby finishing the production of manufacturing the LED light tube of the present invention.

Another distinct feature of the present invention resides in that the LED dies coupled electrically via the conductive elements for various objective can shorten the distance between adjacent pair of the LED dies. Hence an appropriate adjustment can be conducted in order to achieve densely arrangement of the LED dies so that the LED light tubes thus produced can provide a relatively large amount of brightness. At the same time, since shorter gold wires are required for wire bond purpose, tangling among the wires can be avoided during the manufacturing process.

The longitudinal length of the heat dissipation base can be adjusted in accordance with the user requirement, hence the LED light tube of the present invention can be fabricated in different length, thereby reducing and economizing the material cost and simplifying the manufacturing process.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a perspective view of an integrally formed Light Emitting Diode (LED) light tube of the present invention;

FIG. 2A is a first embodiment of the integrally formed LED light tube of the present invention;

FIG. 2B is a top planar view of FIG. 2A;

FIG. 2C is a cross-sectional view of FIG. 2A;

FIG. 3 is a second embodiment of the integrally formed LED light tube of the present invention;

FIG. 4A shows one form of a recess in a heat dissipation base employed in the integrally formed LED light tube of the present invention;

FIG. 4B shows another form of the recess in the heat dissipation base employed in the integrally formed LED light tube of the present invention;

FIG. 5A shows one form of a conductive element employed in the integrally formed LED light tube of the present invention;

FIG. 5B shows another form of the conductive element employed in the integrally formed LED light tube of the present invention; and

FIG. 6 shows utilization of a heat dissipation base in the integrally formed LED light tube of the present invention.

### DETAILED DESCRIPTION OF THE PREFERRED EMBODIMENTS

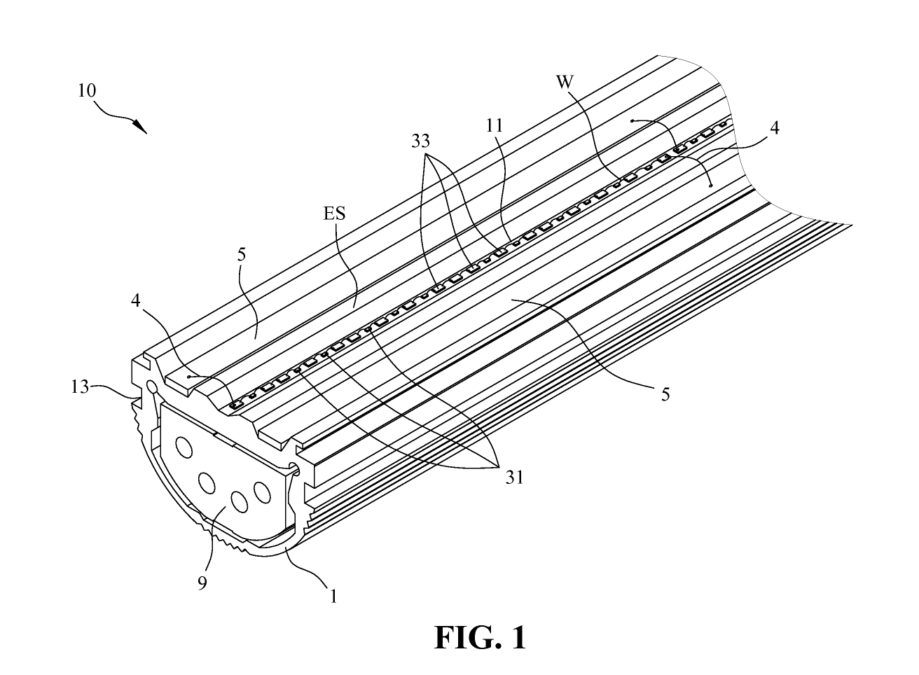

FIG. 1 is a perspective view of an integrally formed Light Emitting Diode (LED) light tube 10 of the present invention. As illustrated, an LED light tube 10 of the present invention includes a heat dissipation base 1 having a light emitting side ES formed with a recess 11 and at least one illumination unit and at least one bridging unit disposed on a bottom surface of the recess 11. The illumination unit and the bridging unit are connected electrically relative to each other via wire-bond technique. The heat dissipation base 1 has a semi-circle shaped and is made from aluminum. The recess 11 of the heat dissipation base 1 has two lateral sides, each extending inclinedly from one end of the bottom surface within a range of 40°˜65°.

The heat dissipation base 1 further has a pair of sliding grooves 13 formed on an outer surface thereof to facilitate transportation of the same during the mass production.

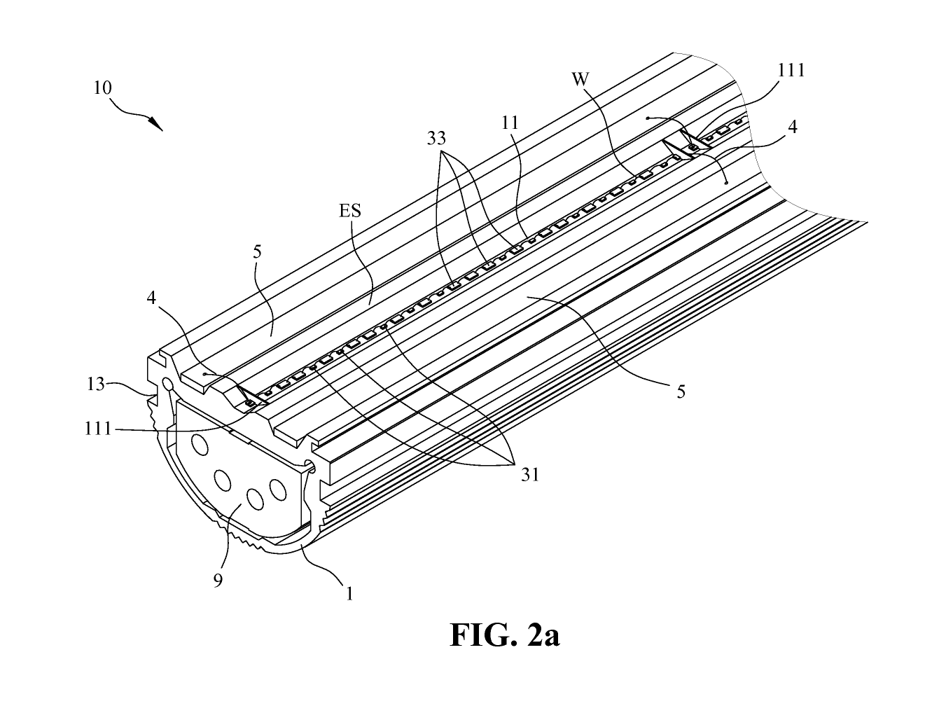

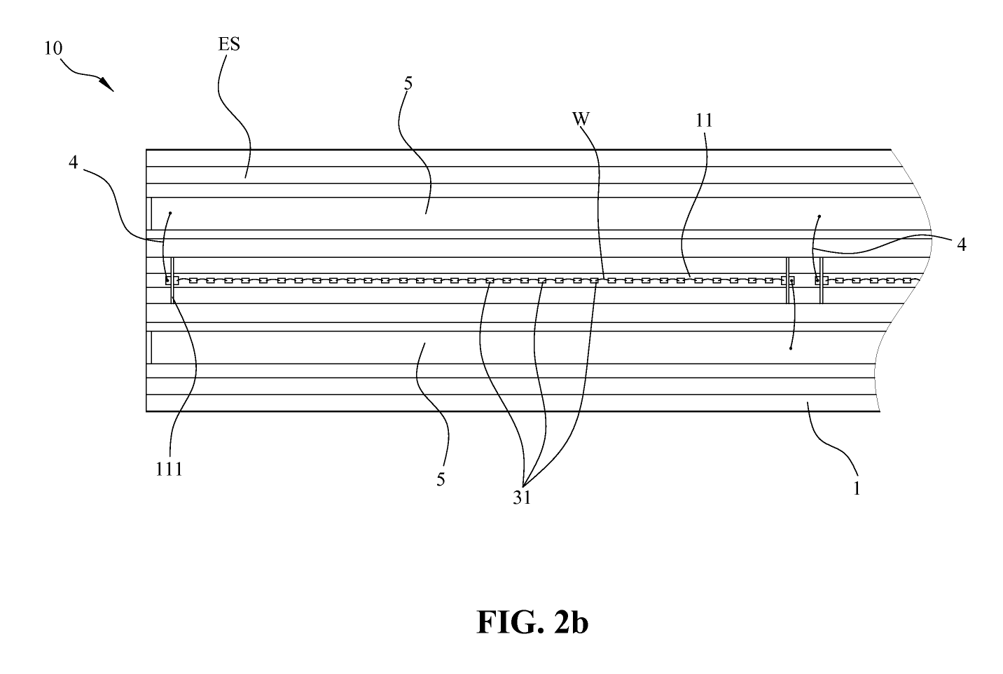

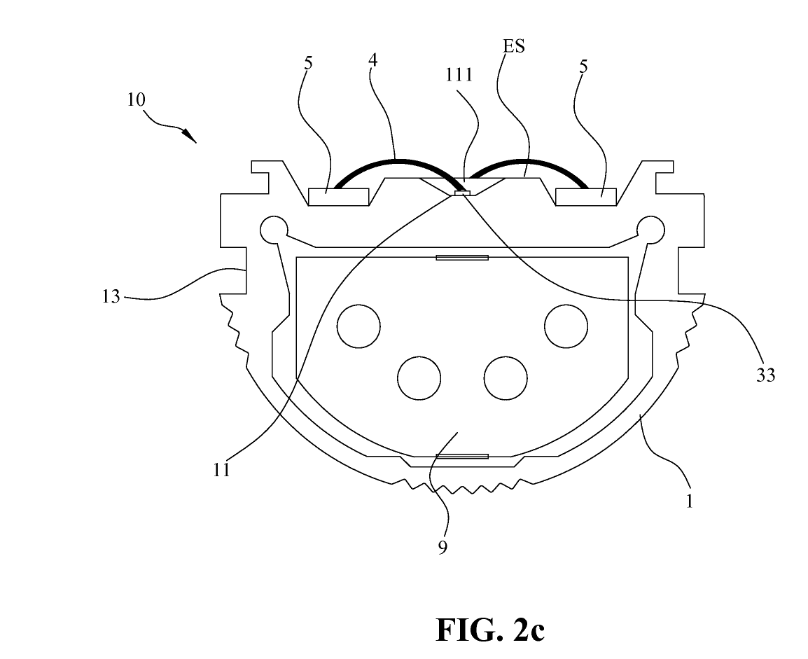

Preferably, the illumination unit is constituted by a plurality of LED dies 31, which are wire bond together while the bridging unit is constituted by a plurality of conductive elements 33, each being disposed between adjacent two of the LED dies 31 or each LED die 31 is disposed between adjacent two of the conductive elements 33, as best shown in FIG. 2A, for electrically bridging the corresponding pair of the conductive elements 33. Alternately, the plurality of the LED dies 31 are mounted on the bottom surface of the recess 11 and are connected electrically to one another in a linear array manner, as best shown in FIG. 2B. However, arrangement of the LED dies 31 and the conductive elements 33 should not be limited only the above-mentioned ways, but should depend on the requirement of the product. When conducting wire bond operation, gold wires W or other conductive wires are implemented.

As illustrated in FIG. 1, the LED light tube 10 of the present invention further includes two circuit units 5 disposed on the light emitting side ES of the heat dissipation base 1 respectively located at two opposite sides of the recess 11. Note that the conductive circuit units 5 and the conductive elements 33 are connected electrically via two external connectors 4 in such a manner that one of the conductive circuits serves as the negative terminal while the other serves as the positive terminal.

Each external connector 4 is located at one end of the recess 11 and transversely crosses the recess 11 to interconnected electrically one conductive circuit 5 to an adjacent one of the conductive element 33, as best shown in FIG. 1. In this embodiment, a printed circuit board (PCB), a ceramic printed circuit board or other printed circuit serves as the conductive circuit 5.

Referring to FIGS. 2A-2C, wherein FIG. 2A is the first embodiment of the integrally formed LED light tube of the present invention, FIG. 2B is a top planar view of FIG. 2A and FIG. 2C is a cross-sectional view of FIG. 2A. As illustrated, the LED light tube 10 of the present invention further includes at least two partition walls 111 formed transversely in the recess 11 at two opposite ends thereof and exposing two of the conductive elements 33 respectively adjacent to the opposite ends. These two conductive elements 33 are connected electrically to the circuit units 5 via the external connectors 4 as described in the above manner. Note that arrangement of the LED dies 31 in FIG. 2A is different from FIG. 2B, in which the LED dies 31 are laid out in linear array manner with only two conductive elements 33 at opposite ends of the recess.

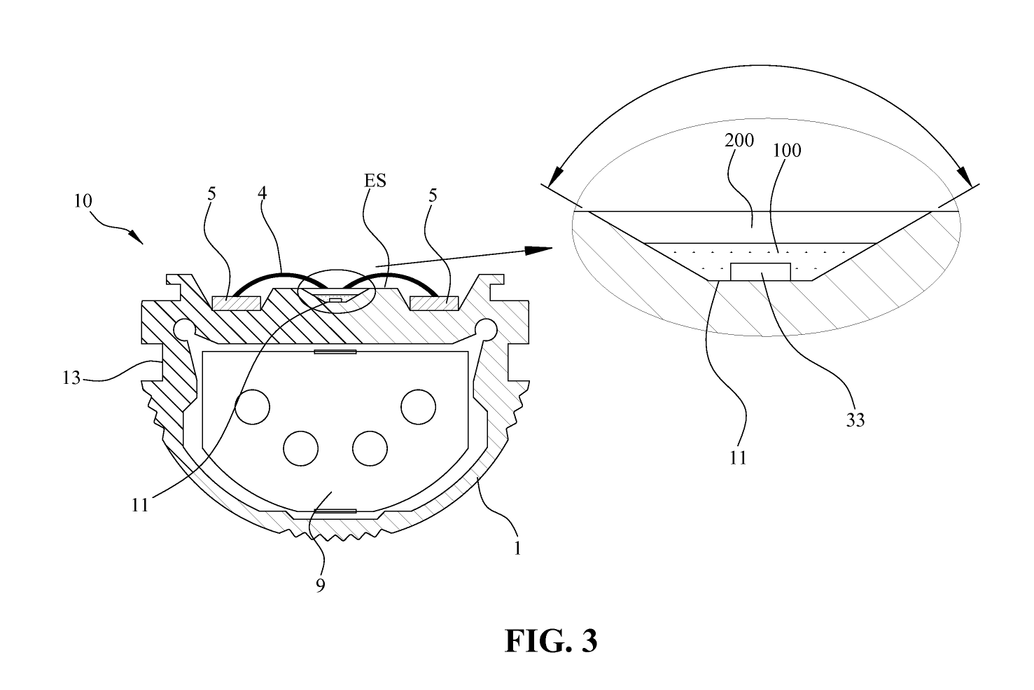

FIG. 3 shows the second embodiment of the integrally formed LED light tube of the present invention. Also referring to FIG. 2C, the LED light tube in this embodiment is similar to the previous one in structure, except an optical layer 100 extending between the partition walls 111 and covering the LED dies 31 and the conductive elements 33 so as to provide optical effects, such as color mixing for the light emitted from the LED dies 31. The optical layer 100 is preferably made from fluorescent glue or material mixture consisting of fluorescent glue and silicon resin. The LED light tube 10 of the present invention further includes a protection layer 200 covering the optical layer 100 so as to isolate the vapor and dust from getting interior of the optical layer 100, thereby damaging the optical effects provided by the layer 100. Preferably, the protection layer 200 is mainly made from silicon resin.

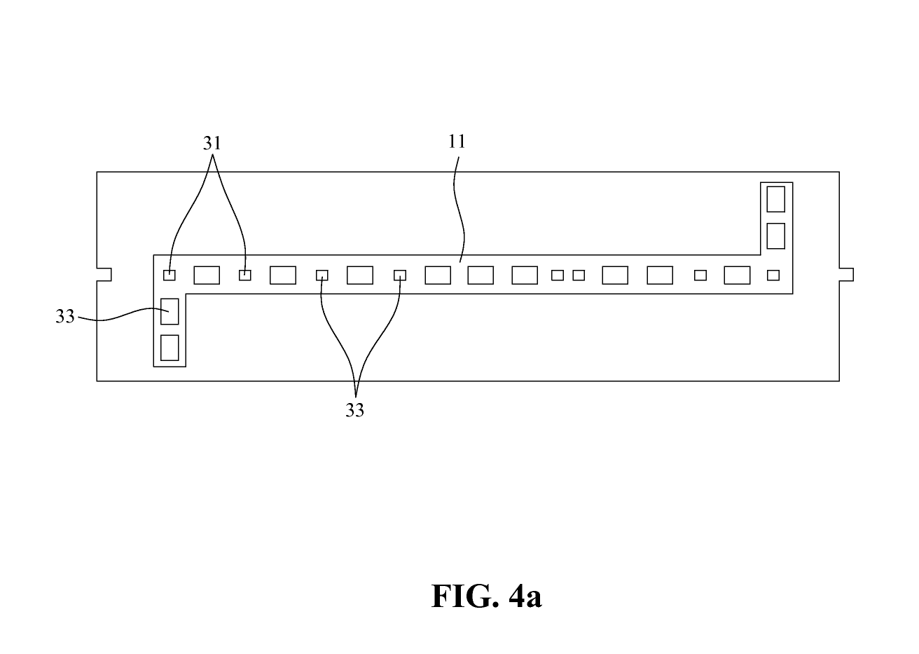

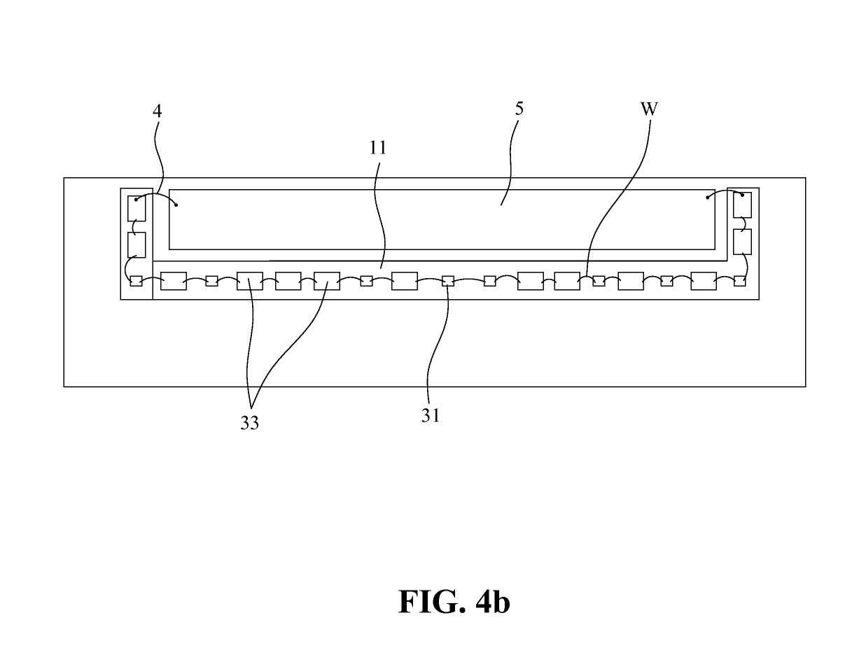

FIG. 4A shows one form of the recess 11 in a heat dissipation base 1 employed in the integrally formed LED light tube of the present invention. The recess 11 is generally S-shaped and has L-shaped end portions at two opposite ends thereof. However, the configuration of the recess 11 should not be limited to only the above-mentioned way, but should depend on the requirement of the product.

FIG. 4B shows another form of the recess 11 in the heat dissipation base 1 employed in the integrally formed LED light tube of the present invention. The recess 11 is generally U-shaped. However, the configuration of the recess 11 should not be limited to only the above-mentioned way, but should depend on the requirement of the product.

Referring again to FIGS. 4A and 4B, wherein arrangement of the LED dies 31 and the conductive elements 33 differs from each other depending on the requirement of the product. As shown in FIG. 4A, each conductive element 33 is disposed between adjacent two of the LED dies 31 in the middle portion while one LED die 31 is arranged between one conductive element 33 and one pair of conductive elements 33 at the end portion thereof. Alternately, one, two or three consecutive conductive elements 33 are arranged between two adjacent pair of the LED dies 31, as best shown in FIG. 4B, depending on the requirement of the product.

In the above embodiment, in order to shorten the electrical connection between the conductive elements 33 and the circuit unit 5, two conductive elements 33 located at two distal ends of the recess 11 being the nearest distance are used for electrical connection to the circuit unit 5 by the external connector 4.

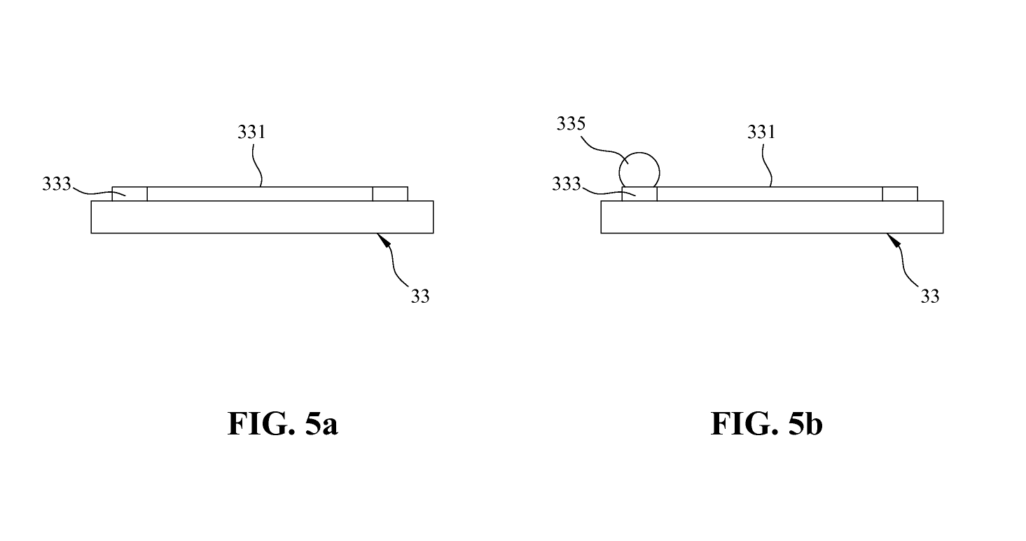

FIG. 5A shows one form of the conductive element 33 employed in the integrally formed LED light tube of the present invention, wherein each of the conductive elements 33 has a top surface formed with a conductive circuit 331 and two joining pads 333 at two opposite ends of the conductive circuit 331 to facilitate wire bonding or soldering purposes during the manufacturing process.

Preferably, each of the conductive elements 33 further includes two soldering balls 335 respectively disposed on the joining pads 333 of a respective one of the conductive elements 33 to facilitate wire bonding or soldering purposes during the manufacturing process.

Note that the external connector 4 transversely crosses the recess 11 and interconnects electrically the respective conductive element 33 and the circuit unit 5 at a position exterior to a nearby partition wall 111 in such a manner that the vapor and dust resulted from the wire bonding or soldering processes are prevented from getting interior of the optical layer 100, thereby maintaining the proper function of those elements kept between the adjacent partition walls 111.

In this embodiment, each of the conductive elements 33 is a multi layer structure having a lower layer made from a silicone wafer, a ceramic chip, glass chip, or non-moisture materials. The lower layer is preferably constituted by from bottom to top a titanium layer and an aluminum layer, each is formed through bumping process.

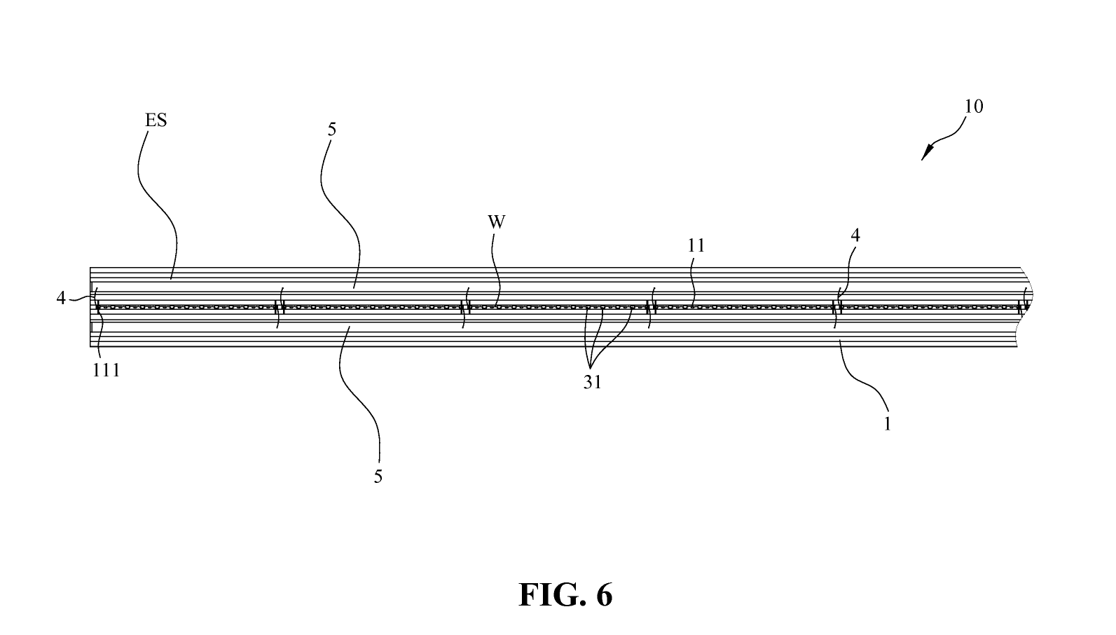

FIG. 6 shows utilization of a heat dissipation base in the integrally formed LED light tube of the present invention. As illustrated, the heat dissipation base 1 has a light emitting surface formed with a plurality of recesses 11 arranged in linear array manner within each of which is disposed at least one illumination unit and a bridging unit so as to conform with various specifications, such as T5-T12 light tubes. The LED light tube of the present invention further includes an LED driver 9 disposed within the recess 11 and coupled electrically to the circuit units 5 and hence for supplying driving voltage to drive the circuit units 5.

The LED light tube of the present provides the following advantages; note that the recess 11 is relatively narrow in width and since the optical layer and the protection layer only need to cover the relatively small width of the recess 11 for shielding the LED dies 31, the cost of material expense is greatly reduced and hence shortening the manufacture time.

One distinct feature of the present invention resides in that once the LED dies are disposed on the bottom surface of the recess in the heat dissipation base, the optical layer and the protection layer can be sequentially disposed over the LED dies, thereby finishing the production of manufacturing the LED light tube of the present invention.

Another distinct feature of the present invention resides in that the LED dies coupled electrically via the conductive elements for various objective can shorten the distance between adjacent pair of the LED dies. Hence an appropriate adjustment can be conducted in order to achieve densely arrangement of the LED dies so that the LED light tubes thus produced can provide a relatively large amount of brightness. At the same time, since shorter gold wires are required for wire bond purpose, tangling among the wires can be avoided during the manufacturing process.

The longitudinal length of the heat dissipation base can be adjusted in accordance with the user requirement, hence the LED light tube of the present invention can be fabricated in different length, thereby reducing and economizing the material cost and simplifying the manufacturing process.

While the invention has been described in connection with what is considered the most practical and preferred embodiments, it is understood that this invention is not limited to the disclosed embodiments but is intended to cover various arrangement included within the spirit and scope of the broadest interpretation so as to encompass all such modifications and equivalent arrangements.

What is claimed is:

1. A Light Emitting Diode (LED) light tube comprising:
a heat dissipation base having a light emitting side formed with a recess and at least one illumination unit and a bridging unit disposed on a bottom surface of said recess, said illumination unit and said bridging unit being connected electrically relative to each other via wire-bond technique; and
two circuit units disposed on said light emitting side of said heat dissipation base respectively located at two opposite sides of said recess.

2. The LED light tube according to claim 1, wherein said heat dissipation base is made from aluminum and has a semi-circle shape.

3. The LED light tube according to claim 1, wherein said recess has two lateral sides, each extending inclinedly from one end of said bottom surface within a range of 40°˜65°.

4. The LED light tube according to claim 1, wherein said illumination unit is constituted by a plurality of LED dies.

5. The LED light tube according to claim 4, wherein said bridging unit is constituted by a plurality of conductive elements, each being disposed between adjacent two of said LED dies or one of said LED dies being disposed between adjacent two of said conductive elements.

6. The LED light tube according to claim 5, further comprising two partition walls 111 formed transversely in said recess at two opposite ends thereof and exposing two of said conductive elements adjacent to said opposite ends.

7. The LED light tube according to claim 6, further comprising an optical layer extending between said partition walls 111 and covering said illumination unit and said bridging unit, said optical layer being made from fluorescent glue or material mixture consisting of fluorescent glue and silicon resin.

8. The LED light tube according to claim 7, further comprising a protection layer covering said optical layer, wherein said protection layer being made from silicone paste.

9. The LED light tube according to claim 8, said circuit units and said conductive elements are connected electrically relative to one another via an external connector.

10. The LED light tube according to claim 5, each of said conductive elements has a top surface formed with a conductive circuit and two joining pads at two opposite ends of said conductive circuit.

11. The LED light tube according to claim 10, further comprising two soldering balls respectively disposed on said joining pads of a respective one of said conductive elements.

12. The LED light tube according to claim 11, wherein each of said conductive elements is a multi layer structure having a lower layer made from a silicone wafer, a ceramic chip or glass chip, said lower layer being constituted by from bottom to top a titanium layer and an aluminum layer, each being formed through bumping process.
